(19) United States
(12) Patent Application Publication
(10) Pub. No.: US 2012/0163283 A1
(43) Pub. Date: Jun. 28, 2012

(54) METHOD FOR RELAYING OF BASE STATION AND METHOD FOR RELAYING OF TERMINAL

(75) Inventors: Sung Kyung KIM, Daejeon (KR); Eunkyung Kim, Daejeon (KR); Sung Cheol Chang, Daejeon (KR); Hyun Lee, Daejeon (KR); Chul Sik Yoon, Seoul (KR)

(73) Assignee: ELECTRONICS AND TELECOMMUNICATIONS RESEARCH INSTITUTE, Daejeon (KR)

(21) Appl. No.: 13/338,221

(22) Filed: Dec. 27, 2011

(30) Foreign Application Priority Data
Dec. 27, 2010 (KR) 10-2010-0135131
Dec. 27, 2010 (KR) 10-2010-0135139
Mar. 2, 2011 (KR) 10-2011-0018497
Mar. 2, 2011 (KR) 10-2011-0018500
Dec. 26, 2011 (KR) 10-2011-0142078
Dec. 26, 2011 (KR) 10-2011-0142079

(51) Int. Cl. H04W 36/00; H04W 88/10; H04W 88/04

(52) U.S. Cl. 370/315

(57) ABSTRACT

A method of relaying in a base station that enable a first base station to operate as a relay station in order to communicate with a second base station that is connected to backhaul, the method includes: forming, by the first base station, a relay link with the second base station; and starting, by the first base station, a relay mode.

### CROSS-REFERENCE TO RELATED APPLICATION

This application claims priority to and the benefit of Korean Patent Application No. 10-2010-0135131, No. 10-2010-0135139, No. 10-2011-0018497, No. 10-2011-0018500, No. 10-2011-0142078, and No. 10-2011-0142079 filed in the Korean Intellectual Property Office on Dec. 27, 2010, Dec. 27, 2010, Mar. 2, 2011, Mar. 2, 2011, Dec. 26, 2011, and Dec. 26, 2011, respectively, the entire contents of which are incorporated herein by reference.

### BACKGROUND OF THE INVENTION

(a) Field of the Invention

The present invention relates to a method of relaying in a base station and a method of relaying in a terminal.

(b) Description of the Related Art

When a disaster or a calamity occurs, important society-based facilities may be broken or damaged. In society-based facilities, various communication facilities such as a base station, relay station, wireless phone, a wired phone, and an Internet network are important infrastructure facilities, and when such a communication facility is broken or damaged, a society is further confused in a disaster or calamity situation and restoration of the society may be difficult. Therefore, in such a case, it is important to provide a means to quickly restore or replace a communication facility.

A relay station is installed in a weak radio area in which a signal from a base station does not reach, and performs a function of securing cell coverage. When a calamity or a disaster occurs, if such a relay station is damaged, it is an important element of communication restoration to provide a means that can replace a function of the relay station.

### SUMMARY OF THE INVENTION

The present invention has been made in an effort to provide a method of relaying in a base station having advantages of performing a smooth communication operation with subordinate terminals by enabling a base station to perform a function of a relay station by setting a relay link with a neighbor base station when a backhaul link of the base station is damaged in a communication system.

The present invention has been made in an effort to further provide a method of relaying in a terminal having advantages of performing a smooth communication operation even in a weak radio area by enabling a terminal to perform a function of a relay station when at least one, for example, a base station or a relay station, of subjects constituting a network in a communication system is broken, or when a network extension is requested for a special mission.

An exemplary embodiment of the present invention provides a method of relaying in a base station that enables a first base station to operate as a relay station in order to communicate with a second base station that is connected to a backhaul, the method including: forming, by the first base station, a relay link with the second base station; and starting, by the first base station, a relay mode.

The first base station may operate in a time-division transmit & receive (TTR) mode or a simultaneous transmit & receive (STR) mode.

The STR mode may sustain a base station function. The method may further include notifying, by the first base station, a subordinate terminal of an execution of handover.

The method may further include reconfiguring, by the first base station, a physical frame.

Another embodiment of the present invention provides a method of relaying in a base station that enables a multimode base station (BS) to operate as a relay station, the method including: transmitting, by the multimode BS in which a backhaul connection is not performed, an advanced air interface multimode advertisement (AAI-MM-ADV) message for a multimode to at least one subordinate terminal; performing, by the multimode BS, ranging with an initial access method in order to request a relay link to a neighbor base station in which a backhaul connection is performed; negotiating, by the multimode BS, a basic performance with the neighbor base station; exchanging, by the multimode BS, authorization, authentication, and a key with the neighbor base station; and forming an operation parameter.

The method may further include: performing, by the multimode BS, a registration procedure with the neighbor base station; and transmitting/receiving a message for a request and acceptance of the relay link to and from the multimode BS.

The AAI-MM-ADV may include information for updating a parameter of a PHY or media access control (MAC) layer.

The AAI-MM-ADV may include an expected time for requesting setting of a relay link.

The at least one subordinate terminal may determine whether to stay at the multimode BS or to perform handover to the neighbor base station based on the expected time.

The multimode BS may sustain connection setting information of the at least one subordinate terminal for the expected time.

Yet another embodiment of the present invention provides a method of relaying in a multimode BS, the method including: transmitting, by the multimode BS, a transmission request message that requests data transmission to a terminal, when communication for setting a relay link is impossible between the multimode BS in which a backhaul connection is not performed and an neighbor base station in which a backhaul connection is performed; and receiving a transmission acknowledgement message from the terminal.

Yet another embodiment of the present invention provides a method of relaying in a terminal that enables the terminal to perform a function of a relay station, the method including: reporting a basic performance including information that can function as the relay station to a base station; receiving an advanced air interface multimode relay station request (AAI_MM_RS_REQ) message from the base station; and transmitting an advanced air interface multimode relay station response (AAI_MM_RS_RSP) message to the base station.

The method may further include receiving a parameter of a PHY or media access control (MAC) layer from the base station.

The method may further include authenticating relay and exchanging a key with the base station.

The method may further include receiving a performance response message, which is a determination result of a relay ability of the terminal, from the base station after the reporting of a basic performance.

The terminal may separately use an identifier for data of the terminal and an identifier for relay data.

The terminal may use a flow identifier (FID) that distinguishes data of the terminal and relay data.

Yet another embodiment of the present invention provides a method of relaying in a terminal that enables the terminal to perform a function of a relay station, the method including: receiving, by a first terminal, another terminal discovery request message from a first base station; transmitting, by the first terminal, the discovery request message to a second terminal; receiving, when the second terminal receives a ranging code from a third terminal, by the first terminal, a discovery response message from the second terminal; and transmitting, by the first terminal, a discovery response message to the first base station.

The second terminal and the third terminal may exist within a propagation range of the damaged first base station. The first terminal may exist within a propagation range of the first base station.

After the transmitting of a discovery response message to the first base station, the first base station may determine whether to set an additional relay station.

### BRIEF DESCRIPTION OF THE DRAWINGS

FIG. 1 is a flowchart illustrating an example of signaling for changing a mode in a method of relaying in a base station according to an exemplary embodiment of the present invention.

FIG. 2 is a flowchart illustrating another example of signaling for changing a mode in a method of relaying in a base station according to another exemplary embodiment of the present invention.

FIG. 3 is a flowchart illustrating an example of a signaling procedure that a base station performs to a terminal in a method of relaying in a base station according to an exemplary embodiment of the present invention.

FIG. 4 is a flowchart illustrating another example of a signaling procedure that a base station performs to a terminal in a method of relaying in a base station according to an exemplary embodiment of the present invention.

FIG. 5 is a flowchart illustrating another example of a signaling procedure that a base station performs to a terminal in a method of relaying in a base station according to an exemplary embodiment of the present invention.

FIG. 6 is a flowchart illustrating signaling for changing a mode in a method of relaying in a base station according to another exemplary embodiment of the present invention.

FIG. 7 is an example of a flowchart illustrating handover generating in a method of relaying in a base station according to an exemplary embodiment of the present invention.

FIG. 8 is another example of a flowchart illustrating handover generating in a method of relaying in a base station according to an exemplary embodiment of the present invention.

FIG. 9 is a diagram illustrating callback handover according to another exemplary embodiment of the present invention.

FIG. 10 is a diagram illustrating an example of a case where a terminal performs a function of a relay station according to another exemplary embodiment of the present invention.

FIG. 11 is a diagram illustrating another example of a case where a terminal performs a function of a relay station according to another exemplary embodiment of the present invention.

FIG. 12 is a flowchart illustrating a method in which a terminal operates as a relay station according to another exemplary embodiment of the present invention.

FIG. 13 is a flowchart illustrating a method of searching for a terminal that is positioned at the outside of a propagation range in a method of relaying in a terminal according to another exemplary embodiment of the present invention.

FIG. 14 is a diagram illustrating an example of a frame configuration of a terminal and a base station according to another exemplary embodiment of the present invention.

FIG. 15 is a diagram illustrating an example of a station identifier (STID) and resource allocation when a terminal operates as a relay station according to an exemplary embodiment of the present invention.

FIG. 16 is a diagram illustrating another example of an STID and resource allocation when a terminal operates as a relay station according to an exemplary embodiment of the present invention.

FIG. 17 is a flowchart illustrating a method of relaying in a terminal according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In the entire specification, a mobile station (MS) may indicate a terminal, a mobile terminal (MT), a subscriber station (SS), a portable subscriber station (PSS), an access terminal (AT), and user equipment (UE), and may include an entire function or a partial function of the terminal, the MT, the SS, the PSS, the AT, and the UE.

Further, a base station (BS) may indicate a node B, an evolved node B (eNode B), an access point (AP), a radio access station (RAS), a base transceiver station (BTS), and a mobile multihop relay (MMR)-BS, and may include an entire function or a partial function of the node B, the eNode B, the AP, the RAS, the BTS, and the MMR-BS.

According to an exemplary embodiment of the present invention, the BS can operate as a relay station in order to communicate with another BS that is connected to a backhaul, and such a BS may be referred to as a multimode BS. When the multimode BS operates in a relay mode, the following three operation methods can be used.

First, a time-division transmit & receive (TTR) mode will be described. The TTR mode uses a new secondary advanced preamble (SA-preamble) and in the TTR mode, channel permutation is changed, and thus a cell reconfiguration is performed. That is, handover with a subordinate terminal is requested due to a relay station (RS) configuration.

Next, a simultaneous transmit & receive (STR) mode will be described. In the STR mode, a BS function is sustained, an existing preamble and channel permutation that are used when operating in a BS mode can be used, and a handover procedure with a subordinate terminal is unnecessary, but a BS ability for the STR mode is requested.

Next, a mixed mode will be described, and the mixed mode operates in the TTR mode, but in an access zone, a BS configuration is sustained. That is, a preamble that is used in a general BS operation is used, channel permutation is sustained without a change in an access zone, and in a relay zone, handover with a subordinate terminal is unnecessary with a change of only channel permutation.

Hereinafter, a method of relaying in a BS will be described in detail with reference to the drawings.

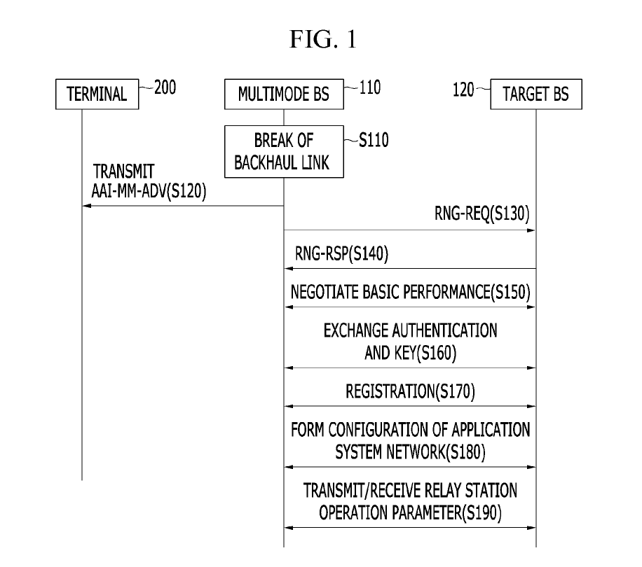

FIG. 1 is a flowchart illustrating an example of signaling for changing a mode in a method of relaying in a BS according to an exemplary embodiment of the present invention.

FIG. 1 illustrates a general relay mode change procedure of a multimode BS 110.

Referring to FIG. 1, when a backhaul link is broken (S110), the multimode BS 110 transmits an advanced air interface multimode advertisement (AAI-MM-ADV) for a multimode function to a terminal 200 (S120). The AAI-MM-ADV notifies the terminal 200 of an approximate service impossible time due to a failure of a backhaul link. In this case, the terminal 200 in which handover can be performed among the terminals 200 in an urgent situation may attempt handover or standby until the multimode BS 110 restarts a service by setting a relay link. Further, while the multimode BS 110 performs communication with a neighbor BS in order to set a relay link, it is difficult for the BS operating in a TTR mode to transmit a downlink synchronization signal for a subordinate terminal and broadcasting information at the same subframe, and thus, by notifying the terminal 200 of a listening segment through the AAI-MM-ADV, the multimode BS 110 can notify a time point for transmitting a synchronization signal and a broadcasting message.

Thereafter, the multimode BS 110 transmits a ranging request message (RNG-REQ) to a target BS 120 (S130), and the target BS 120 transmits a ranging response message (RNG-RSP) to the multimode BS 110 (S140). Here, the target BS 120 is a BS to provide a relay link to replace a backhaul link of the multimode BS to a serving BS of the multimode BS. Here, the RNG-REQ and the RNG-RSP may include BS information and a mode change instruction.

Thereafter, the multimode BS 110 and the target BS 120 negotiate basic performance (S150).

The multimode BS 110 and the target BS 120 exchange authentication and a key (S160), and the multimode BS 110 and the target BS 120 perform registration (S170). In this case, an authentication and registration procedure may be simplified or omitted according to a function. Thereafter, the multimode BS 110 and the target BS 120 form a configuration of an application system network (ASN) (S180).

Thereafter, the multimode BS 110 and the target BS 120 transmit/receive a relay station operation parameter (S190).

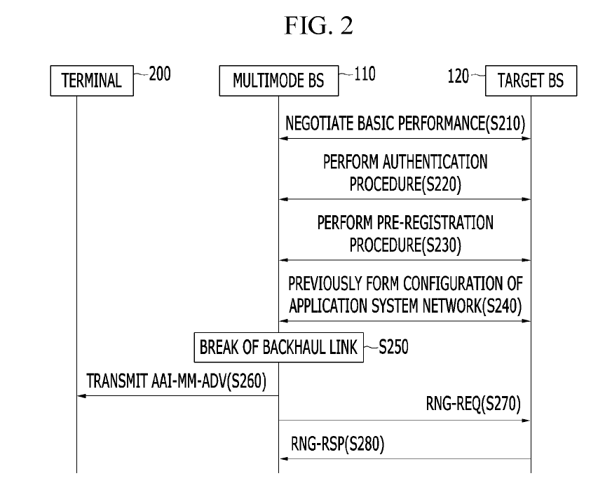

FIG. 2 is a flowchart illustrating another example of signaling for changing a mode in a method of relaying in a BS according to another exemplary embodiment of the present invention.

FIG. 2 illustrates a case where the multimode BS is a pre-configured BS.

Referring to FIG. 2, the multimode BS 110 negotiates basic performance with the target BS 120 (S210). Thereafter, the multimode BS 110 and the target BS 120 perform an authentication procedure (S220) and perform a pre-registration procedure (S230). Thereafter, the multimode BS 110 and the target BS 120 use a previously formed configuration of an application system network (S240). The process of forming the configuration is performed through backhaul communication.

In this case, a backhaul link may be broken (S250).

Thereafter, the multimode BS 110 transmits an AAI-MM-ADV to the terminal 200 (S260). The multimode BS 110 performs a ranging procedure by transmitting an RNG-REQ to the target BS 120 (S270). In this case, the RNG-REQ includes mode change information.

Thereafter, the target BS 120 transmits an RNG-REP to the multimode BS 110 (S280). In this case, the RNG-REP may include relay station operation parameter information. The procedure may use other messages that perform a function of requesting/accepting a relay link (including relay station operation parameter information) as well as an RNG-REQ/RNG-REP.

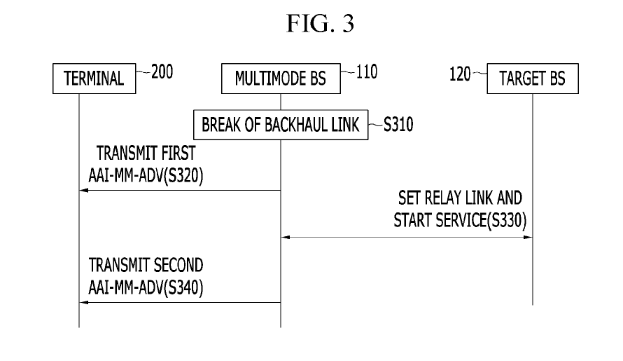

FIG. 3 is a flowchart illustrating an example of a signaling procedure in which a BS performs for a terminal in a method of relaying in a BS according to an exemplary embodiment of the present invention.

FIG. 3 illustrates a case where a physical layer (PHY) of an access zone is not changed.

Referring to FIG. 3, when a backhaul link is broken (S310), the multimode BS 110 transmits a first AAI-MM-ADV to the terminal 200 (S320). Thereafter, the multimode BS 110 sets a relay link and starts a service with the target BS 120 (S330). The multimode BS 110 transmits a second AAI-MM-ADV to the terminal 200 (S340). In this case, the second AAI-MM-ADV notifies the start of a service through a relay link and notifies capacity and quality of a relay link and load information within a cell. By using this, terminals that can perform handover to another cell can use corresponding information for handover triggering.

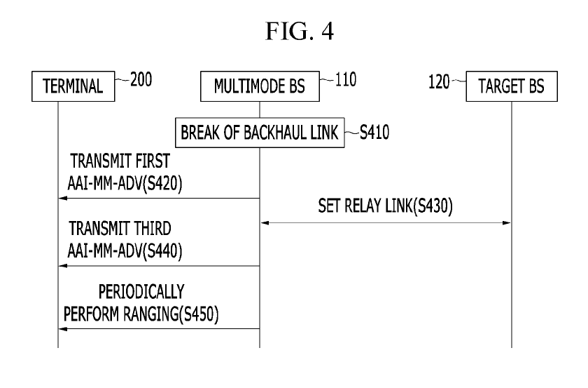

FIG. 4 is a flowchart illustrating another example of a signaling procedure in which a BS performs for a terminal in a method of relaying in a BS according to an exemplary embodiment of the present invention.

FIG. 4 illustrates a case where a PHY of an access zone is changed.

Referring to FIG. 4, when a backhaul link is broken (S410), the multimode BS 110 transmits a first AAI-MM-ADV to the terminal 200 (S420). Thereafter, the multimode BS 110 sets a relay link and starts a service with the target BS 120 (S430). The multimode BS 110 transmits a third AAI-MM-ADV to the terminal 200 (S440). In this case, the third AAI-MM-ADV includes physical frame information to be changed, for example, an index of a SA-preamble, cell configuration and reconfiguration information such as relay mode information, and application start frame information. Further, when capacity and quality of a relay link and load information within a cell, and handover are requested, the third AAI-MM-ADV notifies a group handover command. Here, the group handover command is an information field representing broadcasting or multicast handover request and is information that enables to perform handover without a separate handover ranging procedure.

Thereafter, the physical frame is changed, and the service is started. Thereafter, the multimode BS 110 periodically performs ranging to the terminal 200 (S450).

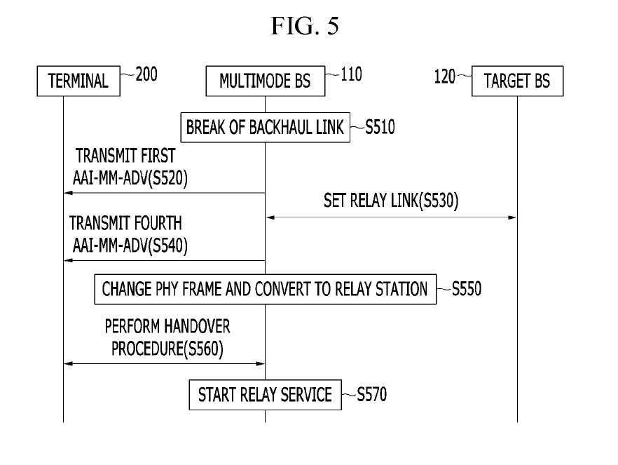

FIG. 5 is a flowchart illustrating another example of a signaling procedure that a BS performs to a terminal in a method of relaying in a BS according to an exemplary embodiment of the present invention.

FIG. 5 illustrates a case where the multimode BS 110 operates as a relay station.

Referring to FIG. 5, when a backhaul link is broken (S510), the multimode BS 110 transmits a first AAI-MM-ADV to the terminal 200 (S520). After the multimode BS 110 sets a relay link with the target BS 120 and starts a service (S530), the multimode BS 110 transmits a fourth AAI-MM-ADV to the terminal 200 (S540). In this case, the fourth AAI-MM-ADV includes information of a PHY frame operating as a relay station and application start frame information, and includes capacity and quality of a relay link, and load information within a cell.

Thereafter, the PHY frame is changed, and the multimode BS 110 is converted to the relay station (S550). Thereafter, the terminal 200 performs a handover procedure with the multimode BS 110 (S560), and the multimode BS 110 starts a service (S570).

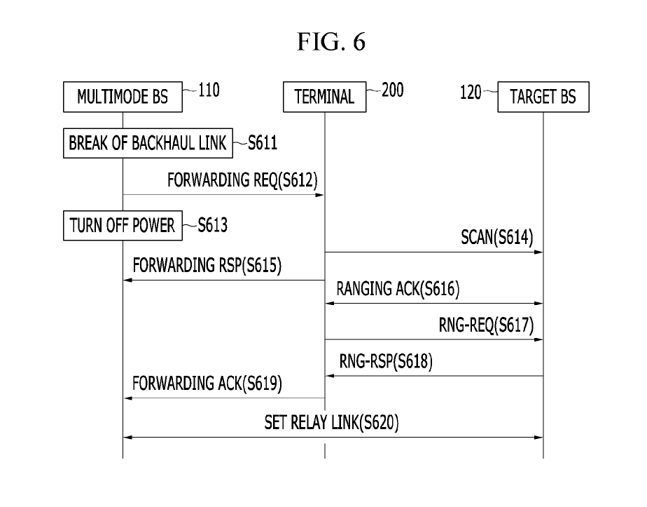

FIG. 6 is a flowchart illustrating signaling for changing a mode in a method of relaying in a BS according to another exemplary embodiment of the present invention.

Referring to FIG. 6, when a backhaul link is broken (S611), if a direct communication link is not available for setting a relay link signal with the target BS 120, i.e., if a wireless communication link between the multimode BS 110 and the target BS 120 is not available, the multimode BS 110 can request data transmission to the terminal 200. For a data transmission request, the multimode BS 110 transmits a forwarding request message (REQ) to the terminal 200 (S612). Here, the forwarding REQ is a message that requests to forward a corresponding message to a neighbor BS to the terminal at a specific time, and includes data that the BS is to transmit to the neighbor BS. The forwarding REQ may include a time point in which the terminal scans a channel of the neighbor BS and a BS message to transmit to the neighbor BS, for example, an RNG-REQ, a BS ID, BS state information, and relay mode request information. The BS may not use a specific frame area at a scan time point of the terminal or may turn off power (S613).

Thereafter, the terminal 200 scans the target BS 120 (S614) and transmits a forwarding RSP to the multimode BS 110 (S615). In this case, the forwarding RSP is a message that notifies a result in which a terminal, having received a forwarding REQ, scans the neighbor BS and that transmits a payload portion to a corresponding BS, if forwarding is available.

Thereafter, the terminal 200 and the target BS 120 perform a CDMA code ranging procedure by transmitting/receiving a ranging acknowledgement message (RNG-ACK) (S616). The terminal 200 notifies that a ranging object is only to forward and transmits an RNG-REQ including a BS ID, a BS state, and a relay request to the target BS 120 (S617). Thereafter, the target BS 120 transmits an RNG-RSP to the terminal 200 (S618).

Thereafter, the terminal 200 transmits a forwarding acknowledgement message (forwarding ACK) to the multimode BS 110 (S619). Here, the forwarding ACK is a message with which a terminal in which forwarding is complete notifies a corresponding BS of this and that forwards, when a response message that is received from a neighbor BS exists, this, and the forwarding ACK includes a payload including a PDU of an RNG-RSP.

Thereafter, the multimode BS 110 and the target BS 120 set a relay link (S620). In this case, the target BS 120 may use a directional antenna in order to set a direct relay link with the multimode BS 110 or increase transmission power. Further, by operating a separate relay station adjacent to the multimode BS 110, a multi-hop relay link can be provided. When a terminal to forward is a multifunctional terminal, the target BS 120 can request to operate a corresponding terminal in a repeater mode.

In a case where it is difficult to form a direct link between the multimode BS 110 and the target BS 120, when the multimode BS 110 operates as only a BS, or when the multimode BS 110 is not a pre-configured relay station, the multimode BS 110 transmits and receives the same message as that of a case of FIG. 1 to and from a separate relay station (not shown) instead of the target BS 120. A description of a detailed message is the same as that of FIG. 1.

In all exemplary embodiments that are described above, while changing a mode, handover may occur. While a service operates, when a service stop time is long, when a relay link has a capacity limitation, when a capacity of a cell is limited due to a factor such as transmission power, a frame structure, and resource allocation, and when the BS is changed and operated as the relay station, handover can be performed. In this case, handover may be classified into general handover, group handover, and callback handover.

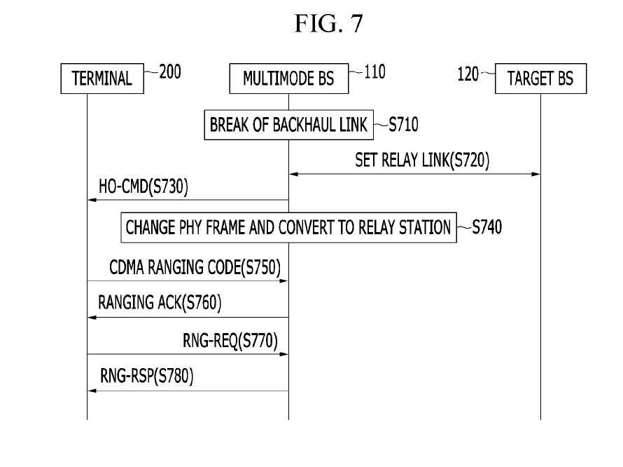

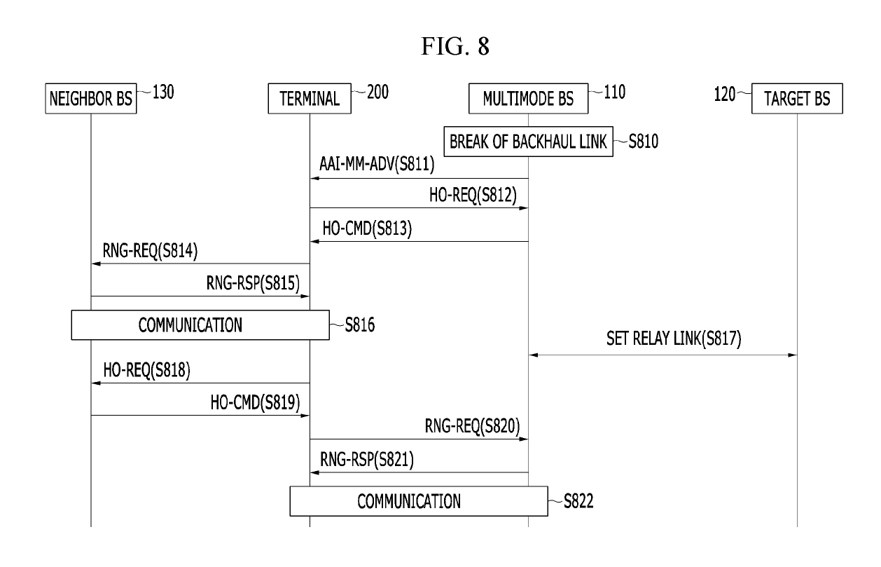

Hereinafter, a handover procedure will be described in detail with reference to FIGS. 7 and 8.

FIG. 7 illustrates an example of a flowchart illustrating handover generating in a method of relaying in a BS according to an exemplary embodiment of the present invention.

Referring to FIG. 7, when a backhaul link is broken (S710), the multimode BS 110, which is a serving BS of the terminal 200, sets a relay link with the target BS 120 for relay (S720). Thereafter, the multimode BS 110 transmits a handover command message (HO-CMD) to the terminal 200 (S730). In this case, the HO-CMD may be a group HO-CMD. The HO-CMD instructs handover by including cell information and a handover time point of a changed relay station, and for group handover of subordinate terminals, the HO-CMD may be broadcasted.

Thereafter, the multimode BS 110 starts a relay operation by changing a PHY frame and converting to a relay station (S740). Thereafter, the terminal 200 transmits a CDMA ranging code to the multimode BS 110 (S750). In this case, the CDMA ranging code may be a dedicated CDMA ranging code.

Thereafter, the multimode BS 110 transmits a ranging acknowledgement message (RNG-ACK) to the terminal 200 (S760). Here, the CDMA ranging code and the RNG-ACK may determine a handover time point according to the order of terminals, and at this time, a dedicated CDMA ranging code may be allocated.

The terminal 200 transmits an RNG-REQ to the multimode BS 110 (S770). Thereafter, the multimode BS 110 transmits an RNG-RSP to the terminal 200 (S780).

FIG. 8 illustrates another example of a flowchart illustrating handover generating in a method of relaying in a BS according to an exemplary embodiment of the present invention.

Referring to FIG. 8, when a backhaul link is broken (S810), the multimode BS 110 transmits an AAI-MM-ADV to the terminal 200 (S811). The AAI-MM-ADV broadcasts a service stop expected time due to a failure of a backhaul link.

Thereafter, the terminal 200 transmits a handover request message (HO-REQ) including an expected time to the multimode BS 110 (S812), and the multimode BS 110 transmits a HO-CMD including an expected time to the terminal 200 (S813). In this case, the expected time is an expected time for requesting setting of a relay link. The expected time may be used for expecting a service stop time of subordinate terminals 200 of the multimode BS 110 in which a backhaul connection is not performed, and may be a time that starts a service using a relay link after an expected time. The subordinate terminal 200 may determine whether to perform handover to another BS 130 or to stay at a present serving BS 110 with reference to the expected time. The BS 110 in which a backhaul connection is not performed may sustain connection setting information of the subordinate terminals 200 for an expected time. In this case, the multimode BS 110 sustains and manages connection information of a terminal for an expected time. When callback handover is available by adding a callback handover enable field to the AAI-MM-ADV, the BS 110 may notify an omission possibility of a transmitting/receiving procedure of the HO-REQ or the HO-CMD.

Thereafter, the terminal 200 transmits an RNG-REQ to the neighbor BS 130, i.e., a target BS for MS for the terminal 200 (S814). The RNG-REQ displays a ranging object instruction, i.e., contents of handover entry due to a break of a backhaul link and notifies the neighbor BS 130 of an expected time and a previous serving BS, i.e., an ID of the multimode BS 110.

Thereafter, the neighbor BS 130 transmits an RNG-RSP to the terminal 200 (S815). Thereafter, the neighbor BS 130 and the terminal 200 perform communication (S816).

Thereafter, a relay link is set between the multimode BS 110 and a BS for relaying 120 (S817).

Thereafter, the terminal 200 transmits a HO-REQ to the neighbor BS 130 (S818), and the neighbor BS 130 transmits a HO-CMD to the terminal 200

(S819).

Thereafter, the terminal 200 transmits an RNG-REQ to the multimode BS 110 (S820), and the multimode BS 110 transmits an RNG-RSP to the terminal 200 (S821). Thereafter, the terminal 200 and the multimode BS 110 perform communication (S822).

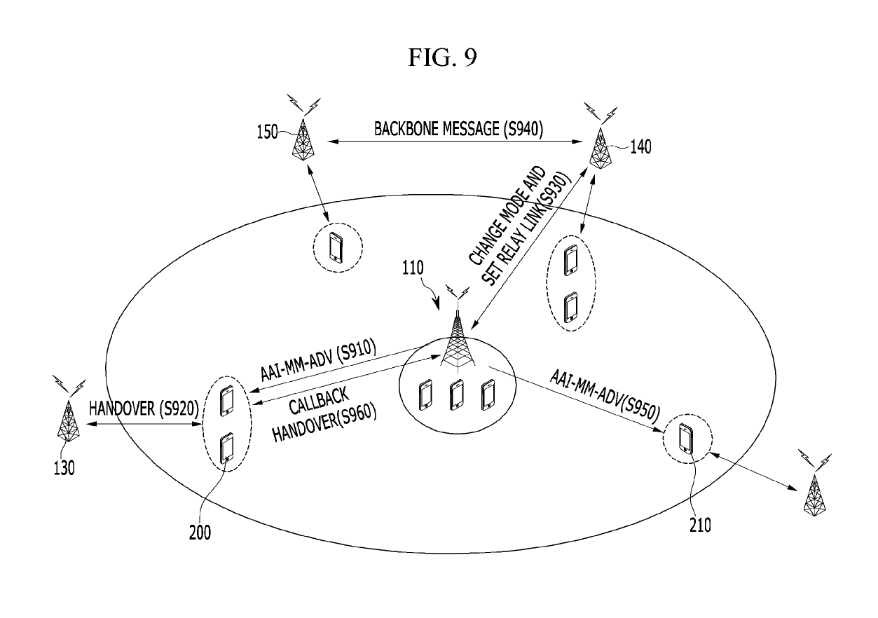

Hereinafter, callback handover will be described in detail with reference to FIG. 9.

FIG. 9 is a diagram illustrating callback handover according to another exemplary embodiment of the present invention.

Referring to FIG. 9, the BS 110 transmits an AAI-MM-ADV to the terminal 200 (S910). The AAI-MM-ADV notifies a service impossible time by a non-connection of a backhaul link and notifies an expected time. The BS 110 sustains connection information of all terminals for an expected time.

The terminal 200 performs handover to the neighbor BS 130 (S920). Before the BS 110 is reconfigured, the terminal 200 can perform handover with the neighbor BS 130, and the terminal 200 having high priority performs handover with the neighbor BS 130. The terminal 200 notifies the neighbor BS 130 of information of the serving BS 110 and expected time information through handover.

The BS 110 changes a mode and sets a relay link with a BS 140 (S930). That is, the BS 110 changes a function to a relay mode and sets a relay link by performing a network entry process with the BS 140.

Thereafter, the BS 140 notifies another BS 150 of a backbone message (S940). The backbone message is a message of notifying another BS 150 of reconfiguration and restart information of the BS 110.

Thereafter, the BS 110 broadcasts reconfiguration and restart information to low-level terminals 210 (S950). Such a process is an option.

Thereafter, the BS 110 changes a parameter of a PHY.

Thereafter, the BS 110 performs callback handover (S960). That is, a corresponding service is started by a ranging process.

Hereinafter, a method of relaying in a terminal according to another exemplary embodiment of the present invention will be described in detail with reference to the drawings.

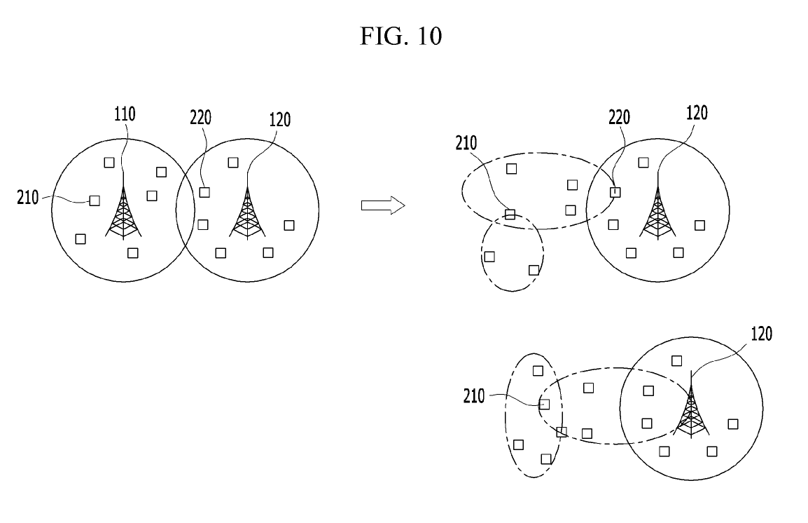

FIG. 10 is a diagram illustrating an example of a case where a terminal performs a function of a relay station according to another exemplary embodiment of the present invention.

Referring to FIG. 10, when each of two BSs 110 and 120 performs a communication service while securing a cell area thereof, the BS 100 may be broken or damaged due to a calamity or a disaster. In such a case, a specific terminal, for example, a terminal 210, having been in a cell area of the BS 110, or a terminal 220, having been in a cell area of the BS 120, performs a function of a relay station, thereby securing a connection to the BS 120 or a backbone network. Thereby, another terminal, having been in a cell area of the BS 110, may receive a communication service.

In this case, the BS 120 detects damage of the BS 110 and selects a terminal to perform a function of a relay station. For this purpose, the BS 120 collects information about position, performance, or wireless link quality of a terminal, and transmits and receives a message to and from a corresponding terminal, performs a network entry procedure, and performs a path discovery procedure for a terminal, having subordinated to the BS 110.

When a signal of the BS 110, having operated, as shown in FIG. 10, is suddenly stopped due to a disaster or a failure thereof, some terminal within the cell may not catch a signal of some BS or relay station, and some terminal 210 can scan a signal of the neighbor BS 120.

In this case, the terminal 210, having scanned a signal of the neighbor BS 120, may attempt a network entry process. In a network entry process, the terminal 210 notifies the target BS 120 of ID of the previous serving BS 110, and thus the corresponding BS 120 determines through backhaul communication whether signal stop is a problem of the BS 110 or a problem that occurs because a radio channel state of the terminal 210 suddenly becomes poor.

The BS 120, having recognized that there is a problem in the BS 110, can request to operate in a relay mode to the terminal 210 adjacent to a corresponding BS of subordinate terminals of the BS 120, i.e., the multifunctional terminal 210 of a performance that can perform a function of the BS.

When a terminal in which a signal of any BS and relay station is not caught even after a predetermined time period has elapsed attempts to perform communication, if a corresponding terminal is a multifunctional terminal, by operating in a BS mode, a self network may be formed, or by a direct communication mode operation, communication with adjacent terminals may be attempted. In this case, a signal collision problem with an existing cell via another terminal discovery procedure should be considered.

When the BS 120 previously recognizes a failure of the BS 110, the BS 120 may request to convert to a relay mode to the subordinate terminal 220 of the BS 120 for communication of subordinate terminals of the BS 110.

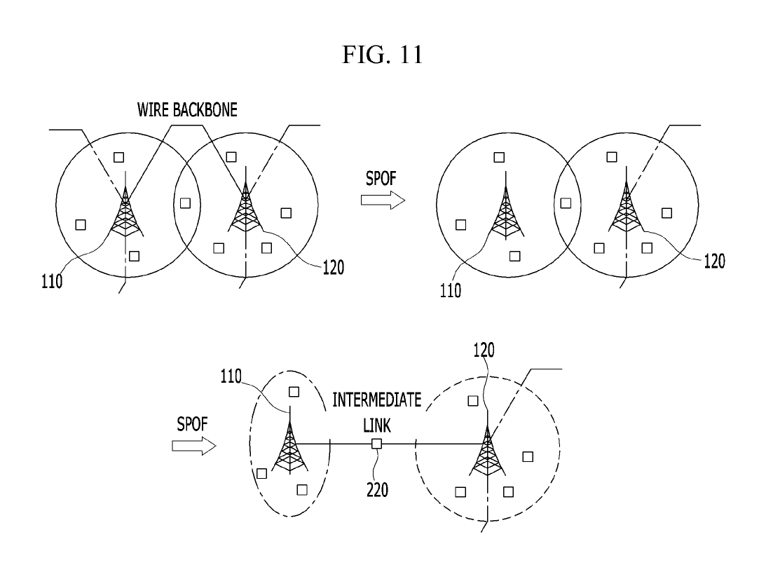

FIG. 11 is a diagram illustrating another example of a case where a terminal performs a function of a relay station according to another exemplary embodiment of the present invention.

Referring to FIG. 11, each of two BSs 110 and 120 performs a communication service while securing a cell area thereof, and the BSs 110 and 120 are connected to a wire backbone network. In this case, by an instruction of the BSs 110 and 120 or a terminal that performs a function of the BS within a cell, another terminal may perform a function of a relay station. In such a case, coverage of the BSs 110 and 120 can be extended, and capacity of the BSs 110 and 120 can be increased.

Further, when a backhaul link is broken, if a direct link state between the BSs 110 and 120 is not good, a specific terminal performs a function of a relay station and thus may replace a backbone connection between the two BSs 110 and 120.

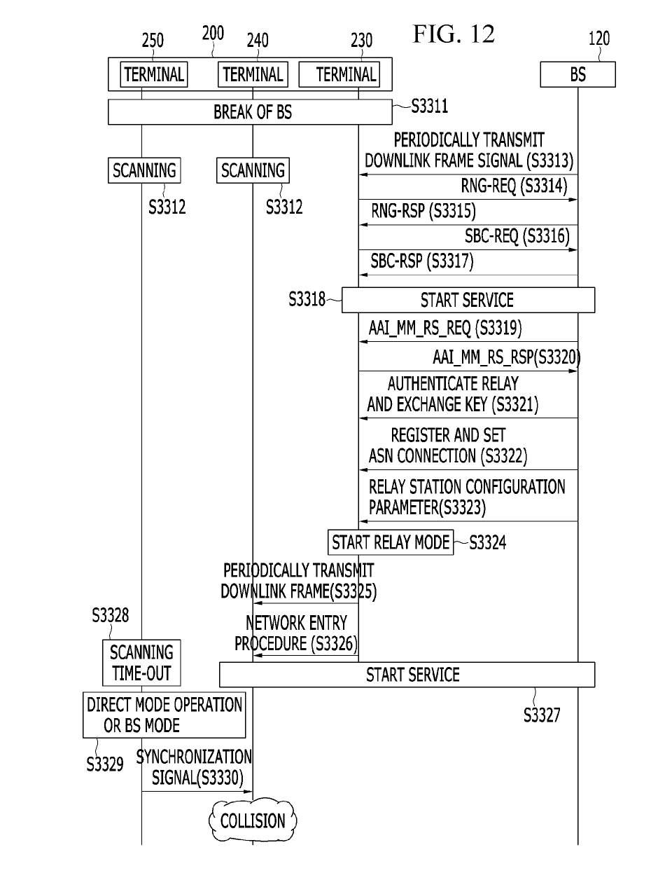

Hereinafter, a method in which a terminal operates as a relay station will be described in detail with reference to FIG. 12.

FIG. 12 is a flowchart illustrating a method in which a terminal operates as a relay station according to another exemplary embodiment of the present invention.

Referring to FIG. 12, there are terminals 230, 240, and 250 having received a service in a cell area of the BS 110. The terminal 230 is a multimode terminal that can operate in a relay mode. Further, a signal propagation range of a neighbor BS 120 is extended to the terminal 230. In this case, when the BS 110 is damaged or broken (S3311), the terminals 240 and 250 scan a peripheral BS (S3312).

The BS 120 attempts backhaul communication with the BS 110, and when communication is not performed, the BS 120 recognizes a failure of the BS 110. The BS 120 periodically transmits a downlink frame signal to the terminal 230 (S3313).

Thereafter, the terminal 230 transmits an RNG-REQ to the BS 120 (S3314). In this case, the RNG-REQ includes a BS ID of the BS 110 having previously received a service.

Thereafter, the BS 120 transmits an RNG-RSP to the terminal 230 (S3315). Thereafter, the terminal 230 transmits a terminal basic performance request message (SBC-REQ) to the BS 120 (S3316). The SBC-REQ includes information about a multimode performance of the terminal 230. Thereafter, the BS 120 determines whether the terminal 230 has a relay ability through the SBC-REQ and transmits a terminal basic performance response message (SBC-RSP) to the terminal 230 (S3317). Thereafter, the BS 120 starts a service for the terminal 230 (S3318). Such a process is a procedure in which the terminal 230 enters a network of the BS 120.

When the BS 120 requests a relay mode operation of the terminal 230, the BS 120 transmits an advanced air interface multimode relay station request (AAI_MM_RS_REQ) to the terminal 230, thereby requesting a relay function to the terminal 230 (S3319). Thereafter, the terminal 230 transmits an advanced air interface multimode relay station response (AAI_MM_RS_RSP) to the BS 120 (S3320). Thereafter, the terminal 230 and the BS 120 authenticate relay and exchange a key (S3321) and register and set an application service network (ASN) connection (S3322). The BS 120 transmits a relay station configuration parameter to the terminal 230 (S3323). Thereafter, the terminal 230 starts a relay mode (S3324). Such a process is a procedure in which the terminal 230 enters a network as a relay station. Relay authentication, key exchange and registration, and ASN connection setting may be omitted. Relay configuration parameters may be included in a relay request message.

A signal propagation range as a relay station of the terminal 230 includes the terminal 240.

The terminal 230 periodically transmits a downlink frame to the terminal 240 (S3325). Thereafter, the terminal 240 performs a network entry procedure to the terminal 230 (S3326). Thereafter, the terminal 230 starts a relay service to the BS 120 for the terminal 240 (S3327).

When scanning is timed-out while a scanning procedure of the terminal 250 is continued (S3328), the terminal 250 directly attempts direct mode operation (DMO) communication or BS mode communication (S3329). In this case, a synchronization signal of the terminal 250 may collide with the terminal 240 (S3330).

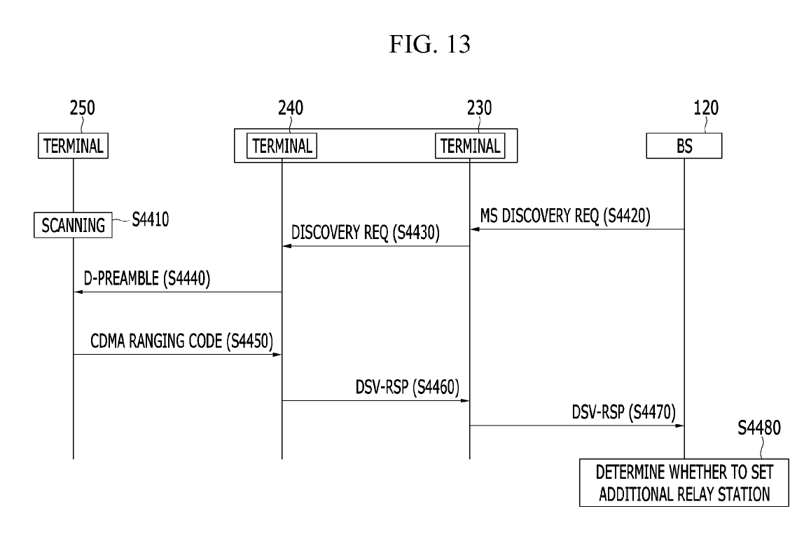

Hereinafter, a method of searching for a terminal that is positioned at the outside of a propagation range will be described in detail with reference to FIG. 13.

FIG. 13 is a flowchart illustrating a method of searching for a terminal that is positioned at the outside of a propagation range in a method of relaying in a terminal according to another exemplary embodiment of the present invention.

FIG. 13 illustrates a case where the terminal 230 and 240 enter a network of the BS 120 when the terminals 230, 240, and 250 exist in a lower part of the BS 110 and the BS 110 is damaged.

When it is determined that an additional search of subordinate terminals of the BS 110 is necessary, the BS 120 transmits a terminal discovery request message (MS discovery REQ) to the terminal 230 (S4420). The MS discovery REQ includes allocation information and a start/end super frame index. In this case, a signal propagation range of the BS 120 includes the terminal 230.

Thereafter, the terminal 230 transmits a discovery request message (DSV-REQ) to the terminal 240 (S4430). A signal propagation range of the terminal 230 includes the terminal 240.

Thereafter, the terminal 240 has a specific sequence pattern that is previously defined in a specification and transmits a D-preamble including an uplink frame to the terminal 250 (S4440). Such a process may be repeated.

Thereafter, the terminal 250 receives a D-preamble, recognizes that a neighbor cell exists at the same frequency, randomly selects one code of a CDMA ranging code set, and transmits the one code to a preset position (S4450). Thereafter, the terminal 240 transmits a discovery response message (DSV-RSP) to the terminal 230 (S4460). The DSV-RSP includes a ranging code index and a carrier to interference and noise ratio (CINR).

Thereafter, the terminal 230 transmits the DSV-RSP to the BS 120 (S4470).

Thereafter, the BS 120 determines whether to set an additional repeater (S4480).

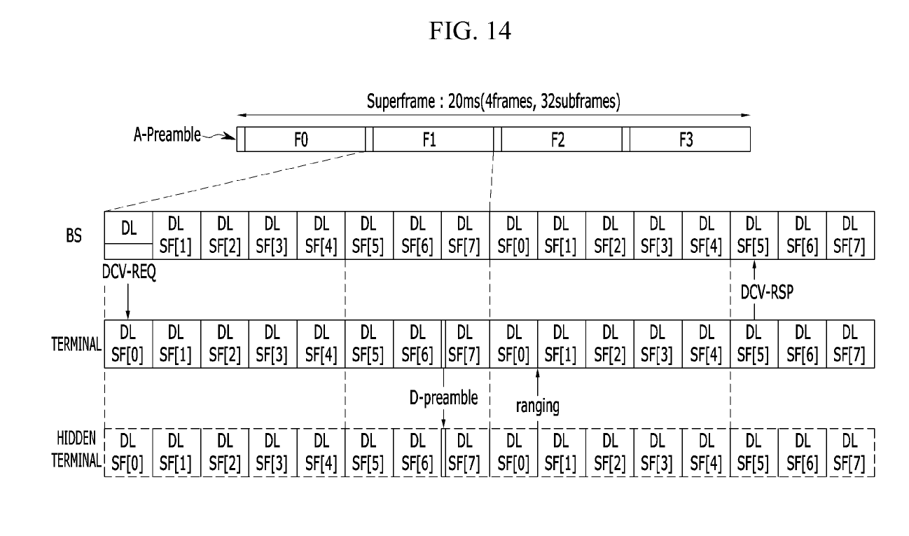

FIG. 14 is a diagram illustrating an example of a frame configuration of a BS, a terminal, and a hidden terminal. Here, the hidden terminal is a terminal at the outside of a propagation range in a relay method of the terminal.

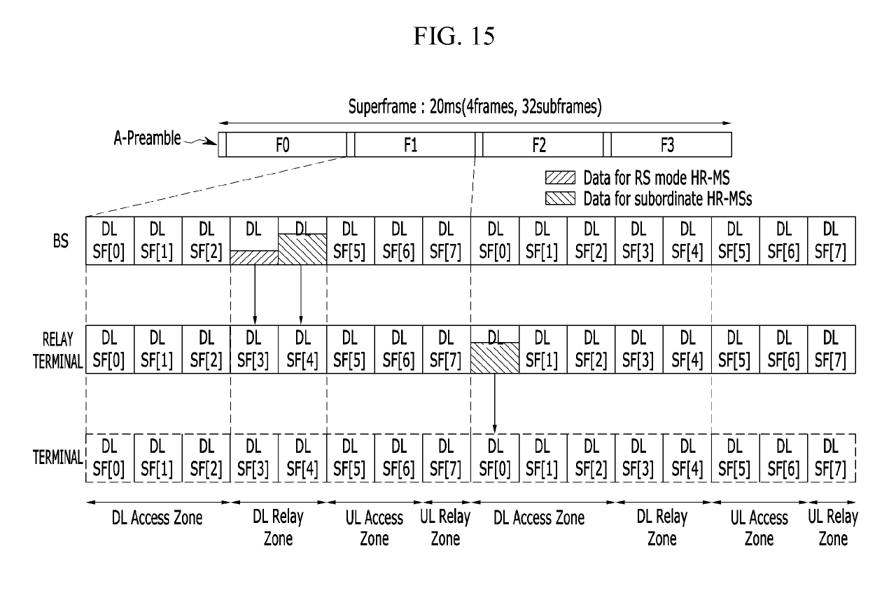

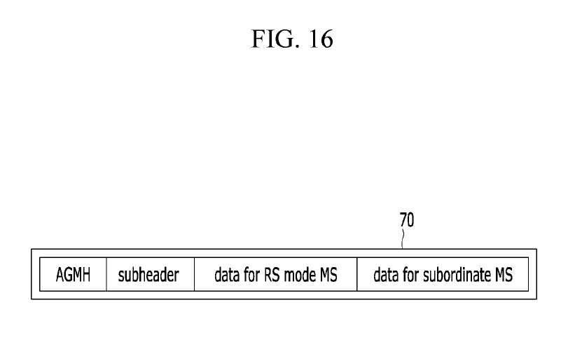

Hereinafter, a method of transmitting/receiving data of the terminal itself and relay data for a subordinate terminal will be described in detail when a terminal operates as a relay station with reference to FIGS. 15 and 16.

FIG. 15 is a diagram illustrating an example of an STID and resource allocation when a terminal operates as a relay station according to an exemplary embodiment of the present invention, and FIG. 16 is a diagram illustrating another example of an STID and resource allocation when a terminal operates as a relay station according to an exemplary embodiment of the present invention.

Referring to FIG. 15, by allocating one STID to the terminal and allocating one STID for a relay mode, data of the terminal itself and relay data for a subordinate terminal are distinguished.

A multifunctional terminal operating in a relay mode separately uses an identifier MS STID that it uses when transmitting/receiving data of the terminal itself and an identifier RS STID that it uses for relay of subordinate terminals. FIG. 15 illustrates a process of receiving data of the terminal and relay data in a downlink relay zone (DL relay zone) and transmitting relay data to subordinate terminals in a DL access zone of a next frame. In this case, data in the DL relay zone may be distinguished by an STID. In order to acquire resource allocation information, the relay mode terminal should search for a map information element (MAP IE) having an STID thereof and a relay STID in a map A-MAP.

Referring to FIG. 16, data of a terminal itself and relay data for a subordinate terminal may be distinguished using one STID allocation and a subheader. In this case, the STID of the terminal of the relay mode is not allocated to the subordinate terminal.

That is, an STID of a multifunctional terminal operating in a relay mode is used as one and is a method of distinguishing relay data and data of a terminal itself with a subheader. This method has a drawback that for communication with the BS, a subheader should always be added in a relay zone. FIG. 16 illustrates a MAC packet data unit (MAC PDU) form in a relay zone that adds and transmits a subheader. In this case, the MAC PDU may transmit relay data and data of a relay mode terminal together, and an identifier for distinguishing whether each traffic set is relay data or data of the terminal may be included in the subheader. When the subheader is an advanced relay forwarding extended header (ARFEH), an STID corresponding to data of each terminal is transmitted to a forwarding ID. In this case, in order to avoid a collision, an STID of a terminal operating in a relay mode is not allocated to a subordinate terminal.

Alternatively, data of a multifunctional terminal that allocates one STID and that operates as a relay station in an access zone may be received. Because data of a multifunctional terminal should be received in an access zone, resource allocation information of an access zone of the BS should be previously known. Alternatively, the multifunctional terminal should operate in an STR mode that sustains a function of the terminal.

That is, an STID of a multifunctional terminal operating in a relay mode is used as one and is a method of distinguishing a data transmitting/receiving area. Transmission/reception of data of the terminal operating in a relay mode is performed in an access zone, and transmission/reception of relay data is performed in a relay zone. For this purpose, in order for a repeater to operate in an STR mode or a TTR mode, for communication in the access zone with the BS, the multifunctional terminal should previously share resource allocation information or be allocated to distinguish from a scheduling position in an access zone for transmission/reception of data in a subordinate terminal thereof.

A final method may be a method of distinguishing data of a terminal itself and relay data for a subordinate terminal with a flow identifier (FID).

An STID of a multifunction terminal operating in a relay mode is used as one, and is a method of distinguishing relay data and data flow of a terminal itself with a FID. That is, resource allocation in a DL relay zone may be performed through one MAP IE, and whether data are relay data or self data thereof may be distinguished by checking FID information within each MAC PDU. In this case, when the number of relay data flows increases, the possible flow number of a multifunctional terminal itself may be limited.

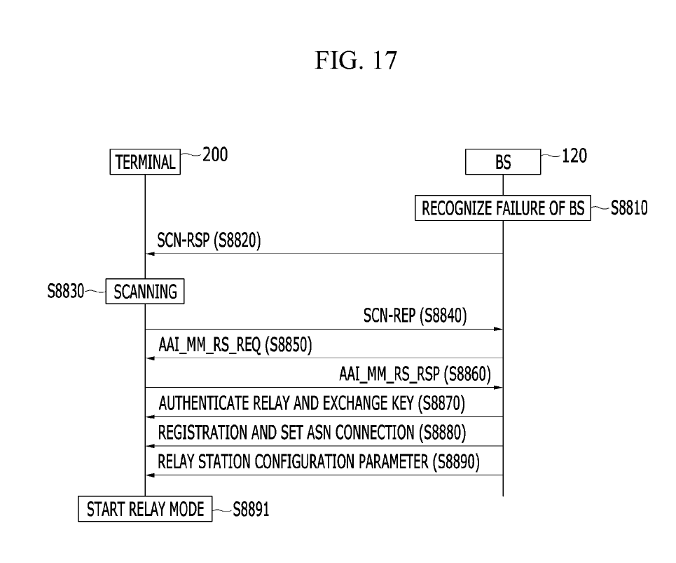

Hereinafter, a method of relaying in a terminal according to another exemplary embodiment of the present invention will be described in detail with reference to FIG. 17.

FIG. 17 is a flowchart illustrating a method of relaying in a terminal according to another exemplary embodiment of the present invention.

Particularly, FIG. 17 illustrates a procedure in which the terminal 200 operating as a BS is changed to a relay station.

Referring to FIG. 17, the BS 120 recognizes a failure of the BS 110 (S8810) and transmits a scanning response message (SCN-RSP) to the terminal 200 (S8820). Thereafter, while continuing to perform a scanning operation, the terminal 200 transmits a scanning report message (SCN-REP) to the BS 120 (S8840) (S8830). Thereafter, the BS 120 determines whether to request a relay function to the terminal 200 based on the SCN-REP. A scan operation of the BS and the terminal is selectively performed.

When the BS requests a relay mode to the terminal 200, the BS 120 transmits a relay request message (AAI_MM_RS_REQ) to the terminal 200 (S8850). The AAI_MM_RS_REQ requests a relay mode operation of a multifunctional terminal 200, and may include STID information or FID information of a relay station, transmission power of a relay station and relay station request function information, and initial relay mode duration time. Here, the initial relay mode duration time is a time that automatically terminates a relay mode when no terminal attempts a connection through a corresponding repeater for the time period, and when an initial relay mode duration time is set as 0, until deregistration is performed, the BS continues a relay mode.

Thereafter, the terminal 200 transmits a relay response message (AAI_MM_RS_RSP) to the BS 120 (S8860) or omits this and immediately transmits an SBC-REQ as a response of affirmation to a relay mode request. The AAI_MM_RS_RSP includes information on whether a relay mode operates. Thereafter, when a relay mode operation can be performed, the terminal 230 performs a necessary relay station network entry procedure. That is, the terminal 200 transmits and receives relay authentication and key to and from the BS 120 (S8870), performs registration and sets an ASN connection (S8880), and receives a relay station configuration parameter from the BS 120 (S8890). Thereafter, the terminal 200 starts a relay mode (S8891).

As a method in which a BS selects a relay terminal, when a scan result of a terminal satisfies a specific condition, the BS may transmit a scan report message to the terminal. For example, when relay conversion is necessary due to a failure of the first BS, it is requested that the second BS selects a multifunctional terminal adjacent to the first BS. A multifunctional terminal adjacent to the first BS may measure that a signal of the first BS suddenly disappears while being received. In this case, when the second BS broadcasts such a scan condition, for example, a received signal change of the first BS through an SCN-RSP message or notifies in a multicast form, the terminal determines whether such a condition is satisfied under the assumption that the terminal generally tracks a measurement value thereof and the terminal satisfying a condition notifies the first BS of a scan result using an existing SCN-REP. Thereafter, a relay mode conversion procedure of the terminal is the same as a procedure of FIG. 17.

According to the present invention, in a communication system, when a backhaul link of a BS is damaged, the BS performs a function of a relay station by setting a relay link with a neighbor BS, thereby performing a smooth communication operation with subordinate terminals.

Further, according to the present invention, in a communication system, when a BS or a relay station is damaged or when a network extension is requested for a special mission, the terminal performs a function of a relay station, thereby performing a smooth communication operation even at a weak radio area.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of relaying in a base station (BS) that enables a first BS to operate as a relay station in order to communicate with a second BS that is connected to a backhaul, the method comprising:
forming, by the first BS, a relay link with the second BS; and
starting, by the first BS, a relay mode.

2. The method of claim 1, wherein the first BS operates in a time-division transmit & receive (TTR) mode or a simultaneous transmit & receive (STR) mode.

3. The method of claim 2, wherein the STR mode sustains a BS function.

4. The method of claim 1, further comprising notifying, by the first BS, a subordinate terminal of an execution of handover.

5. The method of claim 1, further comprising reconfiguring, by the first BS, a physical frame.

6. A method of relaying in a multimode BS that enables the multimode BS to operate as a relay station, the method comprising:
transmitting, by the multimode BS in which a backhaul connection is not performed, an advanced air interface multimode advertisement (AAI-MM-ADV) message for a multimode to at least one subordinate terminal;
performing, by the multimode BS, ranging with an initial access method in order to request a relay link to an neighbor BS in which a backhaul connection is performed;
negotiating, by the multimode BS, a basic performance with the neighbor BS;
exchanging, by the multimode BS, authorization, authentication, and a key with the neighbor BS; and
forming an operation parameter.

7. The method of claim 6, further comprising:
performing, by the multimode BS, a registration procedure with the neighbor BS; and
transmitting/receiving a message for a request and acceptance of the relay link to and from the multimode BS.

8. The method of claim 6, wherein the AAI-MM-ADV comprises information for updating a parameter of a PHY or media access control (MAC) layer.

9. The method of claim 6, wherein the AAI-MM-ADV comprises an expected time for requesting setting of a relay link.

10. The method of claim 9, wherein the at least one subordinate terminal determines whether to stay at the multimode BS or to perform handover to the neighbor BS based on the expected time.

11. The method of claim 9, wherein the multimode BS sustains connection setting information of the at least one subordinate terminal for the expected time.

12. A method of relaying in a multimode BS, the method comprising:
transmitting, by the multimode BS, a transmission request message that requests data transmission to a terminal, when communication is impossible for setting a relay link between a multimode BS in which a backhaul connection is not performed and an neighbor BS in which a backhaul connection is performed; and
receiving a transmission acknowledgement message from the terminal.

13. A method of relaying in a terminal that enables the terminal to perform a function of a relay station, the method comprising:
reporting a basic performance comprising information that can function as the relay station to a BS;
receiving an advanced air interface multimode relay station request (AAI_MM_RS_REQ) message from the BS; and
transmitting an advanced air interface multimode relay station response (AAI_MM_RS_RSP) message to the BS.

14. The method of claim 13, further comprising receiving a parameter of a PHY or media access control (MAC) layer from the BS.

15. The method of claim 13, further comprising authenticating relay and exchanging a key with the BS.

16. The method of claim 13, further comprising receiving a performance response message, which is a determination result of a relay ability of the terminal from the BS, after the reporting of a basic performance.

17. The method of claim 13, wherein the terminal separately uses an identifier for data of the terminal and an identifier for relay data.

18. The method of claim 13, wherein the terminal uses a flow identifier (FID) that distinguishes data of the terminal and relay data.

19. A method of relaying in a terminal that enables the terminal to perform a function of a relay station, the method comprising:
receiving, by a first terminal, another terminal discovery request message from a first BS;
transmitting, by the first terminal, the discovery request message to a second terminal;
receiving, when the second terminal receives a ranging code from a third terminal, by the first terminal, a discovery response message from the second terminal; and
transmitting, by the first terminal, a discovery response message to the first BS.

20. The method of claim 19, wherein the second terminal and the third terminal exist within a propagation range of the damaged first BS.

21. The method of claim 19, wherein the first terminal exists within a propagation range of the first BS.

22. The method of claim 19, wherein after the transmitting of a discovery response message to the first BS, the first BS determines whether to set an additional relay station.
